(19) United States
(12) Patent Application Publication
(10) Pub. No.: US 2026/0171734 A1
(43) Pub. Date: Jun. 18, 2026

(54) ELECTRICAL CONNECTOR ASSEMBLY INCLUDING FLANGE AND BACKING PLATE HAVING ATTACHMENT AND RETENTION FEATURES

(71) Applicant: Aptiv Technologies AG, Schaffhausen (CH)

(72) Inventors: Nicholas DURSE, Youngstown, OH (US); Michael MELLOTT, Youngstown, OH (US)

(21) Appl. No.: 19/394,325

(22) Filed: Nov. 19, 2025

Related U.S. Application Data
(60) Provisional application No. 63/733,121, filed on Dec. 12, 2024.

(51) Int. Cl. H01R 13/74; H01R 13/512; H01R 13/52; H01R 13/6597; H01R 13/703

(52) U.S. Cl. CPC H01R 13/743; H01R 13/512; H01R 13/5202; H01R 13/6597; H01R 13/7036

(57) ABSTRACT

An electrical connector assembly includes a flange configured to be received within an aperture through a first surface of a substrate. The flange has a protruding portion extending through the aperture and a first attachment feature. The connector also includes a backing plate configured to surround the aperture on a second surface of the substrate. The backing plate receiving the protruding portion and having a second attachment feature configured to engage the first attachment feature. The connector further includes an electrical terminal attached to the flange and including a deformable tab extending parallel to an insertion axis of the flange into the aperture. The tab is bendable to engage a second retention feature in the backing plate.

### CROSS-REFERENCE TO RELATED APPLICATIONS

This application claims the benefit of and priority to U.S. Provisional Application No. 63/733,121, titled “Header Designs For Sheet Metal Interface”, filed Dec. 12, 2024, the contents of which are incorporated by reference herein.

### TECHNICAL FIELD

The subject matter disclosed herein relates to electrical connector assemblies and, in particular, to electrical connector assemblies configured to be mounted through a substrate.

### BACKGROUND

High voltage (HV) electrical connector assemblies, such as those used in electric or hybrid electric vehicles, have used a header with a flange that is bolted to a surface of a cover or case of an HV electronic device. The header may provide both environmental sealing and electromagnetic shielding of electrical components of the HV electronic device. Threaded fasteners (bolts) are typically used to attached the header to case. These attachment bolts are exposed to the environment and may be subject to corrosion. They may also present sealing challenges since they may provide a potential leak path.

This interface surface of the cover or case is commonly a rigid cast aluminum substrate. However, some automotive original equipment manufacturers (OEMs) are interested in using a stamped sheet metal case in place of the cast aluminum as a cost savings measure. In this case, if threaded fasteners are used, they require the case to include weld nuts or a backing plate containing threaded holes on the inside of the case to receive the threaded fasteners. These weld nuts or backing plates present assembly challenges and have the before mentioned sealing issues. Therefore, attaching a header to a sheet metal case with threaded fasteners is not favored for a highly automated assembly process. None of these approaches described here have provided a comprehensive solution that combines the features described in this disclosure.

### SUMMARY

In some aspects, the techniques described herein relate to an electrical connector assembly, including a flange configured to be received within an aperture through a first surface of a substrate. The flange has a protruding portion configured to extend through the aperture. The flange also includes a first attachment feature. The electrical connector assembly also includes a backing plate that is configured to surround the aperture on a second surface of the substrate. The backing plate is configured to receive the protruding portion and includes a second attachment feature which is configured to engage the first attachment feature. The electrical connector assembly further includes an electrical terminal that is attached to the flange. The electrical terminal has a first retention feature with a deformable tab extending in a direction parallel to an axis of insertion of the flange into the aperture. The tab is configured to be bent into a configuration engaging a second retention feature in the backing plate.

In some aspects, the techniques described herein relate to a method of assembling an electrical connector assembly. The method includes the step of inserting a protruding portion of a flange within a first aperture through a first surface of a substrate. The protruding portion includes a first attachment feature. The method also includes the step of inserting the protruding portion within a second aperture of a backing plate configured to surround the first aperture on a second surface of the substrate. The backing plate includes a second attachment feature. The method further includes the step of inserting a deformable tab of a first retention feature through the first aperture and the second aperture. The tab is defined by an electrical terminal attached to the flange and extends in a direction that is parallel to an axis for inserting the protruding portion of the flange within the first aperture. The method additionally includes the step of engaging the first attachment feature with the second attachment feature to secure the flange and the backing plate to the substrate.

### BRIEF DESCRIPTION OF THE DRAWINGS

FIG. 1 is a front isometric view of an electrical connector assembly according to some embodiments.

FIG. 2 is a rear isometric view of the electrical connector assembly of FIG. 1 according to some embodiments.

FIG. 3 is a bottom view of the electrical connector assembly of FIG. 1 showing retention features in an unbent condition according to some embodiments.

FIG. 4 is a bottom view of the electrical connector assembly of FIG. 1 showing the retention features of FIG. 3 bent into the locking position according to some embodiments.

FIG. 5 is a cross-sectional side view of the electrical connector assembly of FIG. 1 showing the retention features along the section line 5-5 of FIG. 4 being bent into a locking position according to some embodiments.

FIG. 6 is a close-up bottom view of the electrical connector assembly of FIG. 1 showing the retention feature of FIG. 3 bent into the locking position according to some embodiments.

FIG. 7 is a close-up bottom view of an electrical connector assembly showing a retention feature engaging a backing plate according to some embodiments.

FIG. 8 is a cross-sectional side view of the electrical connector assembly along section line 8-8 in FIG. 1 according to some embodiments.

FIG. 9 is a close-up cross-sectional side view of attachment features in FIG. 8 according to some embodiments.

FIG. 10 is a partial cross-sectional side view of the electrical connector assembly along the section line 10-10 of FIG. 4 according to some embodiments.

FIG. 11 is an isolated isometric view of a flange of the electrical connector assembly of FIG. 1 showing a first spring design according to some embodiments.

FIG. 12 is an isolated isometric view of a flange of the electrical connector assembly of FIG. 1 showing a second spring design according to some embodiments.

FIG. 13 is an isolated isometric view of a flange of the electrical connector assembly of FIG. 1 showing a third spring design according to some embodiments.

FIG. 14 is flowchart of a method of assembling an electrical connector assembly according to some embodiments.

### DETAILED DESCRIPTION

The present disclosure provides a design and method of installation for an electrical connector assembly mounted to a sheet metal housing that does not utilize separate threaded fasteners. This electrical connector assembly utilizes flange and a ‘push-on’ style backing plate with attachment features to secure the backing plate to the flange. A terminal attached to the flange and the backing plate also include a retaining features that further secure the backing plate to the flange. The backing plate may utilize wave springs to apply a force to compress a seal in the flange to the sheet metal housing, thereby fully sealing the interface between the flange and the housing. There are three versions of wave spring presented herein. The first design is a linear wave spring which has a barb in the spring to allow for retention to the backing plate without a secondary retainer piece. The second design is a wave spring with a rectangular opening. The attachment feature uses plastic flex arms that function as both a primary lock and a pre-stage feature prior to engagement of the retention features which provide a secondary lock.

The retention features are integral to the electrical connector assembly and engaged along the same axis as the insertion of the flange into the backing plate which is important for assembly cost savings and packaging. The retention features are integral to the metallic shield terminal which normally just provides electromagnetic compliance (EMC) shielding functionality. In this electrical connector assembly, the shield terminal has a dual purpose. The metallic base material of the shield terminal is not sensitive to polymer creep which makes it a novel feature of this design. The retaining feature is engaged along the same axis as the engagement of the attachment features of the backing plate and flange, which can be done in the same manufacturing step and/or using the same assembly fixture. In some embodiments, the attachment features could be provided by separate parts rather than being integrated with the backing plate and shield terminal, but this is not ideal for manufacturing.

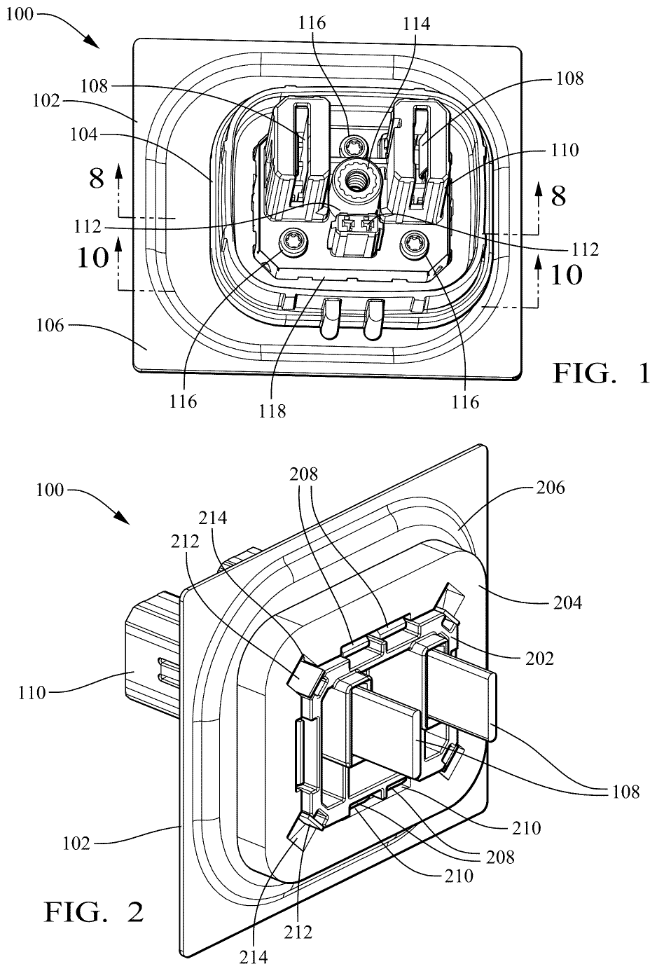

FIGS. 1 and 2 are front and rear isometric views of an electrical connector assembly, hereafter referred to as the assembly 100, attached to a substrate 102, in this embodiment, the substrate is a sheet metal panel of a case containing an electronic device. The assembly 100 includes a flange 104 configured to surround an aperture through a first surface 106 of a substrate 102. The flange 104 has a protruding portion 202 configured to extend through the aperture. The assembly also includes a plurality of electrical terminals connected within a terminal housing 110 attached to the flange 104. In this embodiment, the terminal housing 110 contains two high voltage electrical terminals 108 configured to interconnect with the electronic device within the case. The terminal housing 110 further includes a pair of high voltage interlock (HVIL) terminals 112 that signal a controller (not shown) to disable electrical energy being applied to the two high voltage electrical terminals 108 until the HVIL terminals 112 are shorted together by a shunt in a mating connector (not shown). These HVIL terminals 112 provide a safety feature to prevent unintended contact with energized high voltage electrical terminals 108. The terminal housing 110 also includes an inserted molded threaded nut 114 for attaching the terminal housing 110 to the mating connector. The terminal housing 110 is attached to the flange 104 by a plurality of threaded screws 116. The assembly 100 further includes a shield terminal 118 attached to the flange 104. The shield terminal 118 is configured to interface with a corresponding shield terminal in the mating connector.

The electrical connector assembly also includes a backing plate 204 that is configured to surround the aperture on a second surface 206 of the substrate 102. The protruding portion 202 of the flange 104 defines a first attachment feature in the form of multiple latching arms 208. The latching arms 208 are configured to engage a second attachment feature in the backing plate 204 in the form of multiple notches 210 that are aligned with the latching arms 208 and configured to receive the latches of the latching arms 208 to secure the backing plate 204 to the flange 104.

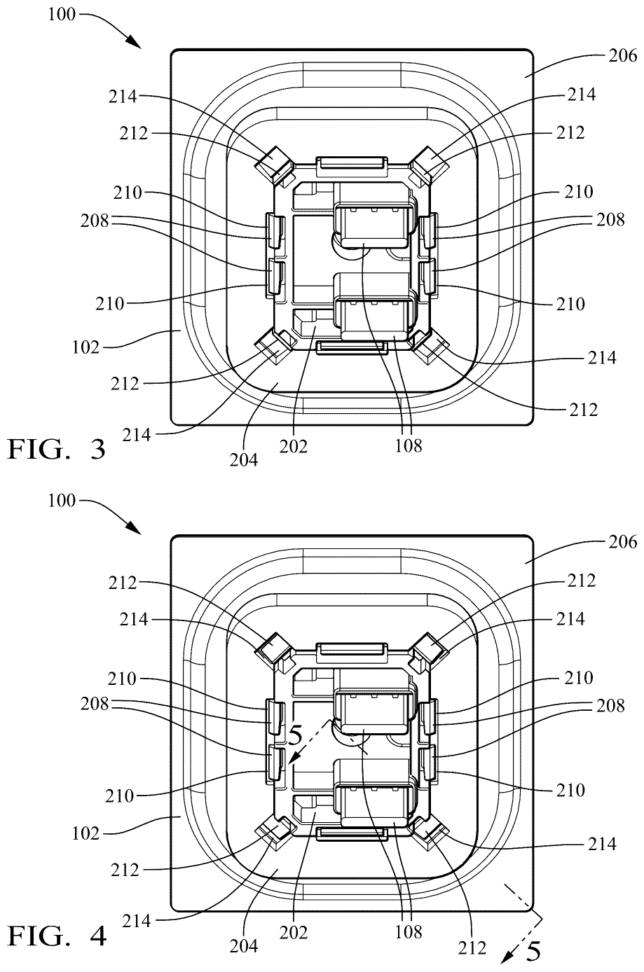

The shield terminal 118 has a first retention feature that includes deformable tabs 212 that extend in a direction parallel to an X axis along which the flange 104 is inserted into the aperture. The deformable tabs 212 are configured to be bent 90° or more into a new configuration engaging a second retention feature in the form of indentations 214 in the backing plate 204, see FIGS. 3 to 6. The tabs 212 and the indentations 214 cooperate to retain the engagement of the latching arms 208 in the notches 210 and further secure the flange 104 and the backing plate 204 to the substrate 102.

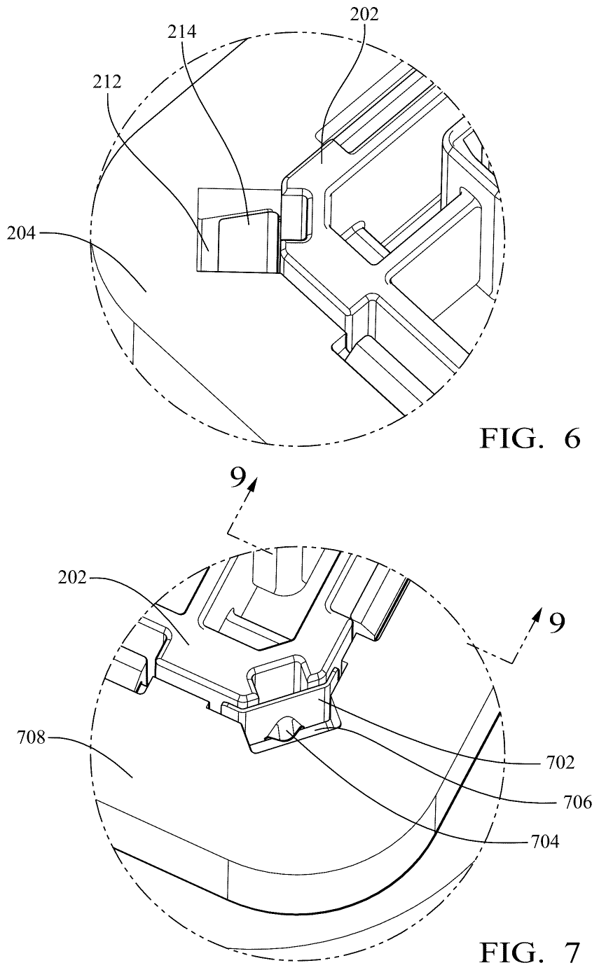

Alternative first and second retention features are shown in FIG. 7. In this embodiment, the first retention features are resilient tabs 702 extending from the shield terminal 118 in a direction parallel to the X axis. The resilient tabs 702 define latches 704 that engage edges 706 of the backing plate 708 that form the second retention features.

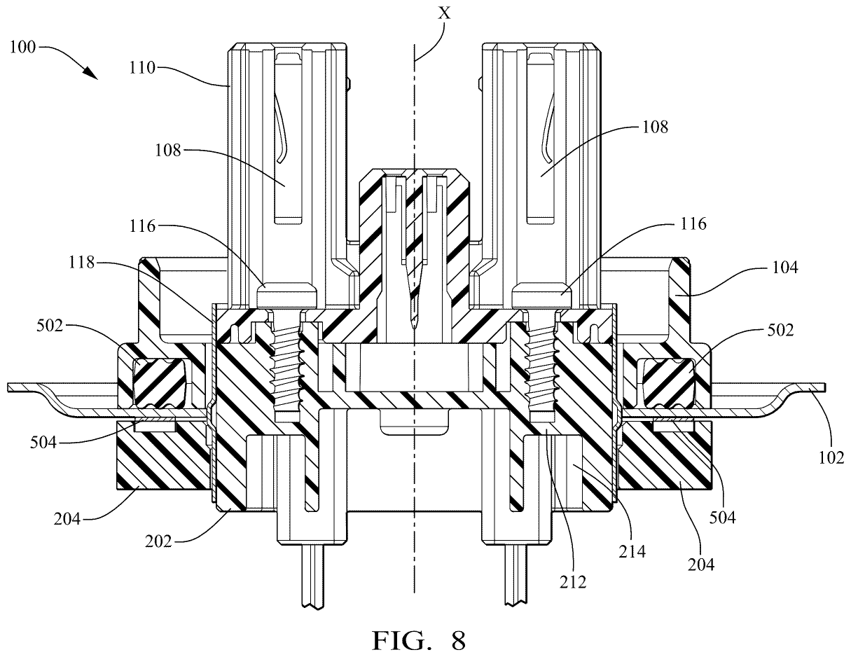

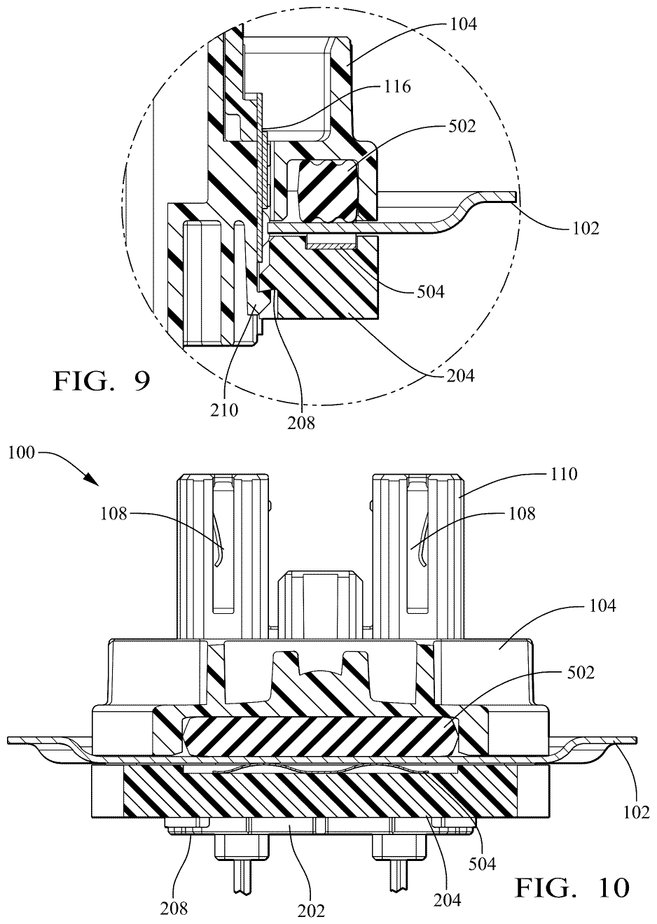

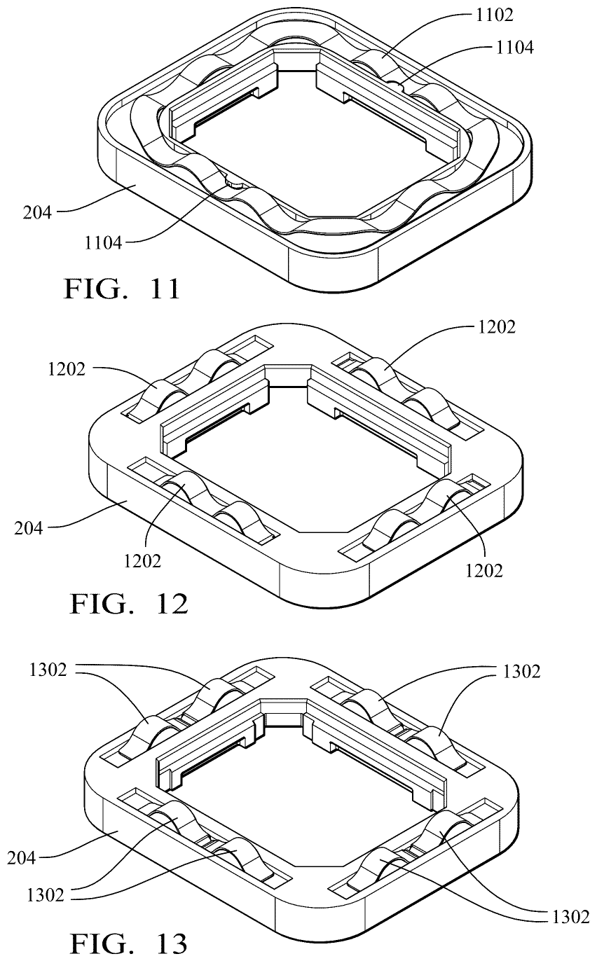

As shown in FIGS. 8 to 10, the flange 104 includes a resilient seal 502 that is configured to seal the flange against the substrate. The seal may be formed of an elastomeric material, such as silicone rubber, and may include a plurality of sealing ribs extending around the periphery of the seal. The backing plate 204 also includes a spring 504 that is configured to exert a compressive force between the flange 104, the seal 502, and the first surface of the substrate. Several different embodiment of the spring 504 are shown in FIGS. 11 to 13.

As shown in FIG. 11, the spring 504 may be a rectangular wave spring 1102 disposed in the backing plate 204 that has a plurality of convex and concave sections. The rectangular wave spring 1102 may be secured to the backing plate by tabs 1104 extending over the rectangular wave spring 1102.

As shown in FIG. 12, the spring 504 may be a plurality of straight wave springs 1202 disposed within the backing plate 204 and spaced around the backing plate 204. Each of the straight wave springs 1202 has a plurality of convex and concave sections. One end of each straight wave spring 1202 may be secured to the backing plate 204.

As shown in FIG. 13, the spring 504 may be a plurality of leaf springs 1302 disposed within the backing plate 204 and spaced around the backing plate 204. Each of the leaf springs 1302 has a convex section. One end of each leaf spring 1302 may be secured to the backing plate 204.

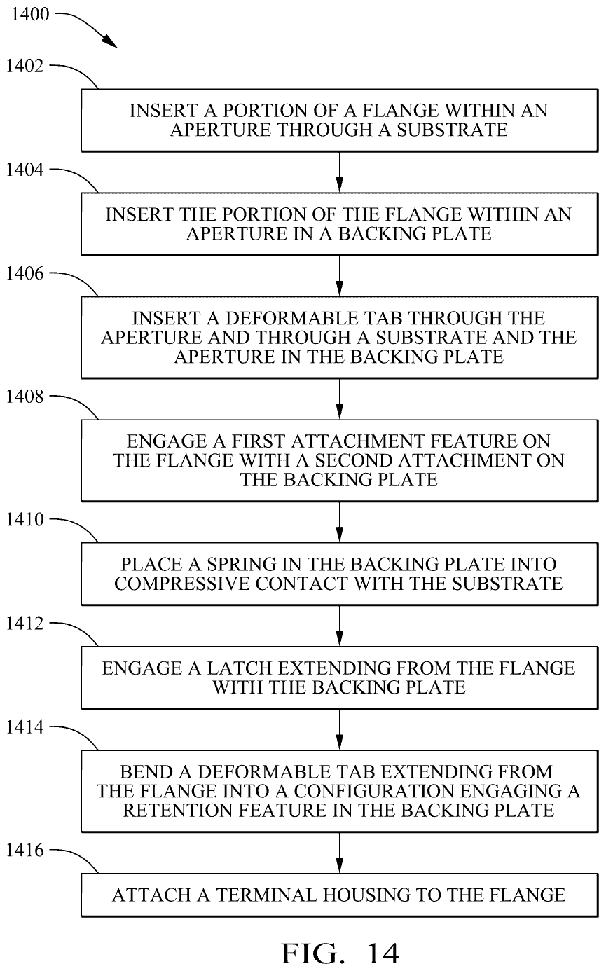

FIG. 14 is flowchart of a method 1400 of assembling an electrical terminal assembly, such as the assembly 100. The method 1400 may include the following steps:

In Step 1402, INSERT A PORTION OF A FLANGE WITHIN AN APERTURE THROUGH A SUBSTRATE, a protruding portion of a flange 104 is inserted within a first aperture through a first surface 106 of a substrate 102. The protruding portion includes a first attachment feature 208.

In Step 1404, INSERT THE PORTION OF THE FLANGE WITHIN AN APERTURE IN A BACKING PLATE, the protruding portion of the flange 104 is inserted within a second aperture in a backing plate 204 that is configured to surround the first aperture on a second surface 206 of the substrate 102. The backing plate 204 includes a second attachment feature 210.

In Step 1406, INSERT A DEFORMABLE TAB THROUGH THE APERTURE AND THROUGH A SUBSTRATE AND THE APERTURE IN THE BACKING PLATE a deformable tab 212 of a first retention feature is inserted through the first aperture and the second aperture. The deformable tab 212 is defined by an electrical terminal 118 attached to the flange 104. The deformable tab 212 extends in a direction parallel to an axis (X) for inserting the protruding portion of the flange 104 within the first aperture. The protruding portion is inserted within the second aperture along the X axis

In Step 1408, ENGAGE A FIRST ATTACHMENT FEATURE ON THE FLANGE WITH A SECOND ATTACHMENT ON THE BACKING PLATE, the first attachment feature is engaged with the second attachment feature to secure the flange 104 and the backing plate 204 to the substrate 102. The first attachment feature may include a cantilevered locking arm 208 and the second attachment feature includes a rigid latch 210.

In Step 1410, PLACE A SPRING IN THE BACKING PLATE INTO COMPRESSIVE CONTACT WITH THE SUBSTRATE, the backing plate 204 includes a spring 504. The flange also includes a resilient seal 502 that is configured to surround the first aperture. The method 1400 further includes placing the spring 504 in compressive contact with the second surface 206 of the substrate 102, thereby exerting a compressive force between the flange 104, the resilient seal 502, and the first surface 106 of the substrate 102.

In Step 1412, ENGAGE A LATCH EXTENDING FROM THE FLANGE WITH THE BACKING PLATE, the deformable tab 702 may include an elastically deformable cantilever beam. A free end of the deformable tab may include a latch 704 configured to engage the backing plate 708. In this instance, the method 1400 further includes engaging the latch 704 with the backing plate 708.

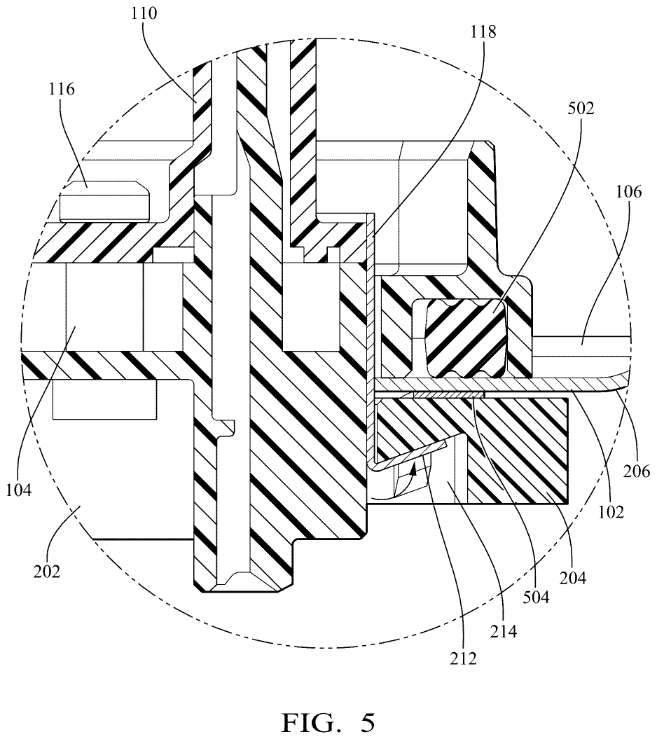

In Step 1414, BEND A DEFORMABLE TAB EXTENDING FROM THE FLANGE INTO A CONFIGURATION ENGAGING A RETENTION FEATURE IN THE BACKING PLATE, the deformable tab 212 may be plastically deformable. In this instance, the method 1400 further includes bending the deformable tab 212 into a configuration engaging a second retention feature 210 in the backing plate 204 as shown in FIG. 5. The deformable tab 212 is bent at least 90° relative to the X axis.

In Step 1416, ATTACH A TERMINAL HOUSING TO THE FLANGE, the electrical terminal may be a shield terminal 118 that is formed of sheet metal. The shield terminal 118 is disposed within a terminal housing 110. In this instance, the method 1400 further includes attaching the terminal housing 110 to the flange 104.

While the illustrated examples are directed to an electrical connector, other embodiments may be envisioned that are configured for use with other connector types, such as fiber optic connectors, pneumatic connectors, hydraulic connectors, or a hybrid connectors combining two or more of these technologies.

While the invention has been described with reference to an exemplary embodiment(s), it will be understood by those skilled in the art that various changes may be made, and equivalents may be substituted for elements thereof without departing from the scope of the invention. In addition, many modifications may be made to configure a particular situation or material to the teachings of the invention without departing from the essential scope thereof. Therefore, it is intended that the invention is not limited to the disclosed embodiment(s), but that the invention will include all embodiments falling within the scope of the appended claims.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc., are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

### Discussion of Possible Embodiments

In some aspects, the techniques described herein relate to an electrical connector assembly, including a flange configured to be received within an aperture through a first surface of a substrate. The flange has a protruding portion configured to extend through the aperture. The flange also includes a first attachment feature. The electrical connector assembly also includes a backing plate that is configured to surround the aperture on a second surface of the substrate. The backing plate is configured to receive the protruding portion and includes a second attachment feature which is configured to engage the first attachment feature. The electrical connector assembly further includes an electrical terminal that is attached to the flange. The electrical terminal has a first retention feature with a deformable tab extending in a direction parallel to an axis of insertion of the flange into the aperture. The deformable tab is configured to be bent into a configuration engaging a second retention feature in the backing plate.

The electrical connector assembly of the preceding paragraph can optionally include, additionally and/or alternatively any, one or more of the following features/steps, configurations, and/or additional components.

For example, the electrical terminal may include a shielding terminal formed of sheet metal and wherein the electrical terminal is disposed within a terminal housing which is attached to the flange.

For example, the deformable tab may be integral with the shielding terminal.

For example, the flange may include a plurality of the first attachment feature, wherein the backing plate includes a plurality of the second attachment feature and the second retention feature. The shielding terminal may include a plurality of the first retention feature.

For example, the backing plate may include a spring configured to exert a compressive force between the flange and the first surface of the substrate.

For example, the flange may include a resilient seal configured to surround the aperture. The spring may be further configured to exert the compressive force between the flange, the resilient seal, and the first surface of the substrate.

For example, the spring may be configured to surround the aperture.

For example, the spring may include a plurality of leaf springs.

For example, the spring may be retained within the backing plate.

For example, the first attachment feature may include a cantilevered locking arm and the second attachment feature may include a rigid latch.

For example, the deformable tab may be plastically deformable and may be bent at least 90° relative to the axis of insertion of the flange.

For example, the deformable tab may include an elastically deformable cantilever beam. A free end of the deformable tab may include a latch configured to engage the backing plate.

In some aspects, the techniques described herein relate to a method of assembling an electrical connector assembly. The method includes the step of inserting a protruding portion of a flange within a first aperture through a first surface of a substrate. The protruding portion includes a first attachment feature. The method also includes the step of inserting the protruding portion within a second aperture of a backing plate configured to surround the first aperture on a second surface of the substrate. The backing plate includes a second attachment feature. The method further includes the step of inserting a deformable tab of a first retention feature through the first aperture and the second aperture. The deformable tab is defined by an electrical terminal attached to the flange and extends in a direction that is parallel to an axis for inserting the protruding portion of the flange within the first aperture. The method additionally includes the step of engaging the first attachment feature with the second attachment feature to secure the flange and the backing plate to the substrate.

The system/method of the preceding paragraph can optionally include, additionally and/or alternatively any, one or more of the following features/steps, configurations, and/or additional components.

For example, the inserting the protruding portion within the second aperture step may be performed along the axis.

For example, the backing plate may include a spring. The method may further include placing the spring in compressive contact with the second surface of the substrate, thereby exerting a compressive force between the flange and the first surface of the substrate.

For example, the flange may include a resilient seal configured to surround the first aperture. The spring may be further configured to exert the compressive force between the flange, the resilient seal, and the first surface of the substrate.

For example, the first attachment feature may include a cantilevered locking arm, and the second attachment feature may include a rigid latch.

For example, the deformable tab may be plastically deformable. The method may further include bending the deformable tab into a configuration engaging a second retention feature in the backing plate, and wherein the deformable tab is bent at least 90° relative to the axis.

For example, the deformable tab may include an elastically deformable cantilever beam. A free end of the deformable tab may include a latch configured to engage the backing plate. The method may further include engaging the latch with the backing plate.

For example, the electrical terminal may be a shielding terminal formed of sheet metal. The electrical terminal may be disposed within a terminal housing. The method may further include attaching the terminal housing to the flange.

1. An electrical connector assembly, comprising:
a flange configured to be received within an aperture through a first surface of a substrate, the flange having a protruding portion configured to extend through the aperture, the flange comprises a first attachment feature;
a backing plate configured to surround the aperture on a second surface of the substrate, the backing plate configured to receive the protruding portion and comprising a second attachment feature configured to engage the first attachment feature; and
an electrical terminal attached to the flange comprising a first retention feature having a deformable tab extending in a direction parallel to an axis of insertion of the flange into the aperture, the deformable tab configured to be bent into a configuration engaging a second retention feature in the backing plate.

2. The electrical connector assembly in accordance with claim 1, wherein the electrical terminal comprises a shielding terminal formed of sheet metal and wherein the electrical terminal is disposed within a terminal housing which is attached to the flange.

3. The electrical connector assembly in accordance with claim 2, wherein the deformable tab is integral with the shielding terminal.

4. The electrical connector assembly in accordance with claim 2, wherein the flange comprises a plurality of the first attachment feature, wherein the backing plate comprises a plurality of the second attachment feature and the second retention feature, and wherein the shielding terminal comprises a plurality of the first retention feature.

5. The electrical connector assembly in accordance with claim 1, wherein the backing plate comprises a spring configured to exert a compressive force between the flange and the first surface of the substrate.

6. The electrical connector assembly in accordance with claim 5, wherein the flange comprises a resilient seal configured to surround the aperture and wherein the spring is further configured to exert the compressive force between the flange, the resilient seal, and the first surface of the substrate.

7. The electrical connector assembly in accordance with claim 5, wherein the spring is configured to surround the aperture.

8. The electrical connector assembly in accordance with claim 5, wherein the spring comprises a plurality of leaf springs.

9. The electrical connector assembly in accordance with claim 5, wherein the spring is retained within the backing plate.

10. The electrical connector assembly in accordance with claim 1, wherein the first attachment feature comprises a cantilevered locking arm and the second attachment feature comprises a rigid latch.

11. The electrical connector assembly in accordance with claim 1, wherein the deformable tab is plastically deformable and is bent at least 90° relative to the axis of insertion of the flange.

12. The electrical connector assembly in accordance with claim 1, wherein the deformable tab comprises an elastically deformable cantilever beam and wherein a free end of the deformable tab comprises a latch configured to engage the backing plate.

13. A method of assembling an electrical connector, comprising:
inserting a protruding portion of a flange within a first aperture through a first surface of a substrate, the protruding portion comprises a first attachment feature;
inserting the protruding portion within a second aperture of a backing plate configured to surround the first aperture on a second surface of the substrate, the backing plate comprising a second attachment feature;
inserting a deformable tab of a first retention feature through the first aperture and the second aperture, the deformable tab defined by an electrical terminal attached to the flange and extending in a direction parallel to an axis for inserting the protruding portion of the flange within the first aperture; and
engaging the first attachment feature with the second attachment feature to secure the flange and the backing plate to the substrate.

14. The method in accordance with claim 13, wherein inserting the protruding portion within the second aperture is performed along the axis.

15. The method in accordance with claim 13, wherein the backing plate comprises a spring and wherein the method further comprises placing the spring in compressive contact with the second surface of the substrate, thereby exerting a compressive force between the flange and the first surface of the substrate.

16. The method in accordance with claim 15, wherein the flange comprises a resilient seal configured to surround the first aperture and wherein the spring is further configured to exert the compressive force between the flange, the resilient seal and the first surface of the substrate.

17. The method in accordance with claim 13, wherein the first attachment feature comprises a cantilevered locking arm and the second attachment feature comprises a rigid latch.

18. The method in accordance with claim 13, wherein the deformable tab is plastically deformable, wherein the method further comprises bending the deformable tab into a configuration engaging a second retention feature in the backing plate, and wherein the deformable tab is bent at least 90° relative to the axis.

19. The method in accordance with claim 13, wherein the deformable tab comprises an elastically deformable cantilever beam, wherein a free end of the deformable tab comprises a latch configured to engage the backing plate, and wherein the method further comprises engaging the latch with the backing plate.

20. The method in accordance with claim 13, wherein the electrical terminal is a shielding terminal formed of sheet metal, wherein the electrical terminal is disposed within a terminal housing, and wherein the method further includes attaching the terminal housing to the flange.
